(19) United States
(12) Patent Application Publication
(10) Pub. No.: US 2013/0220426 A1
(43) Pub. Date: Aug. 29, 2013

(54) Method, Apparatus, and System for Controlling the Exhaust of a Vacuum Device

(71) Applicant: Richard Vinson, Idaho City, ID (US)

(72) Inventor: Richard Vinson, Idaho City, ID (US)

(73) Assignee: EMERSON ELECTRIC CO., St. Louis, MO (US)

(21) Appl. No.: 13/407,176

(22) Filed: Feb. 28, 2012

(51) Int. Cl. F17D 1/00

(52) U.S. Cl. 137/1; 138/37

(57) ABSTRACT

Described is a method, apparatus, and system for controlling the exhaust of a vacuum device including at least two conduits capable of routing air within the vacuum device, at least two baffles, at least two air chambers, and at least two exhaust cavities. The baffles and the air chambers are capable of reducing the turbulence of the routed air. The exhaust cavities are capable of discharging the routed air from the vacuum device as two or more converging air streams thus minimizing any adverse effects on the environment or the operator. The system can further include a diffuser capable of increasing the turbulence of the routed air after the vacuum device discharges the routed air to improve the thermal dissipation of the discharged routed air. The system can further include a mounting device capable of coupling the vacuum device to a vacuum operator for increased portability.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to controlling the exhaust of a vacuum device. In one of the aspects, the invention relates specifically to an apparatus, wherein the apparatus is adapted to discharge exhaust air from a vacuum device as two or more converging air streams in order to minimize the exhaust's adverse effects on the environment and the operator. In further aspects, the invention relates to diffusing the discharged air in order to maximize the thermal dissipation of the vacuum device's exhaust.

2. Description of the Related Art

For years, vacuum cleaners have been used to remove contaminants, dirt, dust, debris, and the like from floors, furniture, and various other surfaces. By creating a pressure differential between the vacuum cleaner and its ambient environment, these cleaning tools generate a suction force that is highly effective for removing debris from these various surfaces. By creating by pressure differential, dirt and debris are forced from the environment to the vacuum cleaner for collection and removal.

As a result of this suction process, vacuum cleaners produce exhaust that must be filtered, discharged, and reintroduced into the ambient environment. This exhausted air often causes complications during the cleaning process, however, because the air can easily interfere with the operator and the surrounding environment during the vacuum cleaner's operation. For example, because the exhausted air is typically highly turbulent, it can disturb dirt or other contaminates in the environment. Moreover, a vacuum cleaner's exhaust can cause fatigue or discomfort for the operator if the exhausted air is directed at the operator's body. Further, the exhaust can produce a disruptive airflow that can disturb files, papers, stationary, or any other lightweight home or office articles or paperwork. This is especially true for mounted vacuum cleaners (such as a backpack-style cleaner often used in commercial or is industrial environments) where the vacuum cleaner and its exhausted air are completely obscured from the operator's view during operation.

One common solution to mitigate the adverse effects created by the exhausted air is to add an additional layer of material in order to baffle and diffuse the airflow. For example, an open-cell permeable foam can be inserted at the exhaust port in order to reduce the exhaust's adverse effects on the environment. Alternately, other solutions include employing a series of ducts or louvers to mechanically deflect the exhausted air. By adding one or more of these materials, the exhaust flow can be better-regulated in order to mitigate its disruptive effects on the environment. These solutions, however, often create additional problems for the vacuum cleaner's operator during operation.

For example, U.S. Pat. No. 7,627,928 to Crevling, Jr. et al. (“Crevling”) describes a removable internal air diffuser for regulating discharged airflow of a vacuum cleaner. More specifically, Crevling discloses a removable cap assembly that comprises a frame though which discharged airflow passes. The frame can include a reticulated foam roll disposed in the frame to diffuse the discharged airflow and reduce the noise effected by its discharge.

U.S. Pat. No. 4,683,608 to Berfield et al. (“Berfield”) discloses an alternate blower outlet for a vacuum cleaner that employs multiple ducts to route exhaust airflow through a vacuum. More specifically, Berfield teaches a series of ducts and valves that can be used to control the flow of the exhausted air depending on whether an outlet hose is attached to the unit. By employing these multiple ducts, Berfield can regulate the exhausted airflow into the external atmosphere in order to quietly diffuse the exhaust depending on the vacuum's mode of operation.

U.S. Pat. No. 5,946,771 to Bosyj et al. (“Bosyj”) discloses a vacuum cleaner air exhaust arrangement that includes a series of vertically extending guiding vents to baffle exhaust airflow. More specifically, Bosyj describes discharging vacuum cleaner exhaust through vertically extending louvers that additionally serve as support features for mounting a final filter to the unit.

These prior art solutions, however, have several drawbacks. For example, the use of permeable foam or mechanical louvers to diffuse the airflow can cause undue strain on the operator and reduce the performance of the vacuum cleaner. Additionally, although many of these solutions can significantly reduce the noise produced by the exhausted air, these features fail to produce exhaust with a non-turbulent, laminar flow to mitigate adverse effects to the surrounding environment as described above. Accordingly, the inventions disclosed and taught herein are directed to a method, apparatus, and system for controlling the exhaust of a vacuum device that overcomes the problems set forth above.

### BRIEF SUMMARY OF THE INVENTION

The present invention is directed to a method, apparatus, and system for controlling the exhaust of a vacuum device. The turbulence of the discharged exhausted air is reduced in order to minimize the adverse effects on the environment and the operator.

The disclosure provides a method, apparatus, and system for controlling the exhaust of a vacuum device including at least two conduits capable of routing air within the vacuum device, at least two baffles, at least two air chambers, and at least two exhaust cavities. The baffles and the air chambers are capable of reducing the turbulence of the routed air. The exhaust cavities are capable of discharging the routed air from the vacuum device as two or more converging air streams thus minimizing any adverse effects on the environment or the operator. The system can further include a diffuser capable of increasing the turbulence of the routed air after the is vacuum device discharges the routed air to improve the thermal dissipation of the discharged routed air. The system can further include a mounting device capable of coupling the vacuum device to a vacuum operator for increased portability.

The disclosure also provides method for controlling the exhaust of a vacuum device that can include the step of routing air from a first location to a second location of the vacuum device though at least two conduits. The first location can be an external surface of an air filter and the second location can be a location external to the vacuum device. The at least two conduits can further include at least two air chambers. The at least two air chambers can be configured to further reduce the turbulence of the routed air.

The method can further include the step of providing at least two baffles to reduce the turbulence of the routed air and the step of discharging the routed air through at least two exhaust cavities. At least one of the at least two baffles can be disposed within the at least two conduits. The step of routing air through at least two conduits can include routing the air through at least two conduits such that a width of at least a portion of the at least two conduits is larger than the height of at least a portion of the at least two conduits. The method can further include the step of increasing the turbulence of the routed air after it is discharged from the vacuum device. Furthermore, the at least two baffles and the at least two air chambers can be configured to reduce the turbulence of the routed air by channeling the routed air into at least two converging airstreams.

The disclosure also provides an apparatus for controlling the exhaust of a vacuum device that can include at least two conduits capable of routing air from a first location to a second location of the vacuum device. The first location can be an external surface of an air filter and the second location can be a location external to the vacuum device. The at least two conduits can further include at least two air is chambers. The at least two air chambers can be configured to further reduce the turbulence of the routed air.

The apparatus can further include at least two baffles capable of reducing the turbulence of the routed air and at least two exhaust cavities. At least one of the at least two baffles can be disposed within the at least two conduits capable of discharging the routed air from the vacuum device. Further, the width of at least a portion of the at least two conduits can be larger than the height of at least a portion of the at least two conduits. The apparatus can further include a diffuser capable of increasing the turbulence of the routed air after it is discharged from the vacuum device. Furthermore, the at least two baffles and the at least two air chambers can be configured to reduce the turbulence of the routed air by channeling the routed air into at least two converging airstreams.

The disclosure also provides a system for controlling the exhaust of a vacuum device. The system can include a vacuum device and a mounting device that is capable of coupling the vacuum device to a vacuum operator. The vacuum device can include at least two conduits capable of routing air from a first location to a second location of the vacuum device. The at least two conduits can further include at least two air chambers. The at least two air chambers can be configured to further reduce the turbulence of the routed air.

The system can further include at least two baffles capable of reducing the turbulence of the routed air and at least two exhaust cavities. At least one of the at least two baffles can be disposed within the at least two conduits capable of discharging the routed air from the vacuum device. Further, the width of at least a portion of the at least two conduits can be larger than the height of at least a portion of the at least two conduits. The apparatus can further include a diffuser capable of increasing the turbulence of the routed air after it is discharged from the vacuum device. Furthermore, the at least two baffles and the at least two air chambers can be configured to reduce the turbulence of the routed air by channeling the routed air into at least two converging airstreams.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates an isometric view of a first embodiment of an apparatus for controlling the exhaust of a vacuum device.

FIG. 2 illustrates a side view of a first embodiment of an apparatus for controlling the exhaust of a vacuum device.

FIG. 3 illustrates a top view of a first embodiment of an apparatus for controlling the exhaust of a vacuum device.

FIG. 4 illustrates a front view of a first embodiment of an apparatus for controlling the exhaust of a vacuum device.

FIG. 5A illustrates a partially exploded front detailed view of a first embodiment of the air filter.

FIG. 5B illustrates a top view of a first embodiment of the air filter.

FIG. 6 illustrates a detailed front view of a first embodiment of an apparatus for controlling the exhaust of a vacuum device.

FIG. 7 illustrates a first embodiment of a system for controlling the exhaust of a vacuum device.

FIG. 8 illustrates a flow diagram depicting an exemplary method for controlling the exhaust of a vacuum device.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

Applicant has created a method, apparatus, and system for controlling the exhaust of a vacuum device including at least two conduits capable of routing air within the vacuum device, at least two baffles, at least two air chambers, and at least two exhaust cavities. The baffles and the air chambers are capable of reducing the turbulence of the routed air. The exhaust cavities are capable of discharging the routed air from the vacuum device as two or more converging air streams thus minimizing any adverse effects on the environment or the operator. The system can further include a diffuser capable of increasing the turbulence of the routed air after the vacuum device discharges the routed air to improve the thermal dissipation of the discharged routed air. The system can further include a mounting device capable of coupling the vacuum device to a vacuum operator for increased portability.

In another embodiment, the method can include the step of routing air from a first location to a second location of the vacuum device though at least two conduits. The method can further include the step of providing at least two baffles to reduce the turbulence of the routed air and the step of discharging the routed air through at least two exhaust cavities. Further, the method can include the step of increasing the turbulence of the routed air after it is discharged from the vacuum device.

In another embodiment, the apparatus can include at least two conduits capable of routing air from a first location to a second location of the vacuum device. The apparatus can further include at least two baffles capable of reducing the turbulence of the routed air and at least two exhaust cavities and at least two exhaust cavities capable of discharging the routed air from the vacuum device. Furthermore, the apparatus can include a diffuser capable of increasing the turbulence of the routed air after it is discharged from the vacuum device.

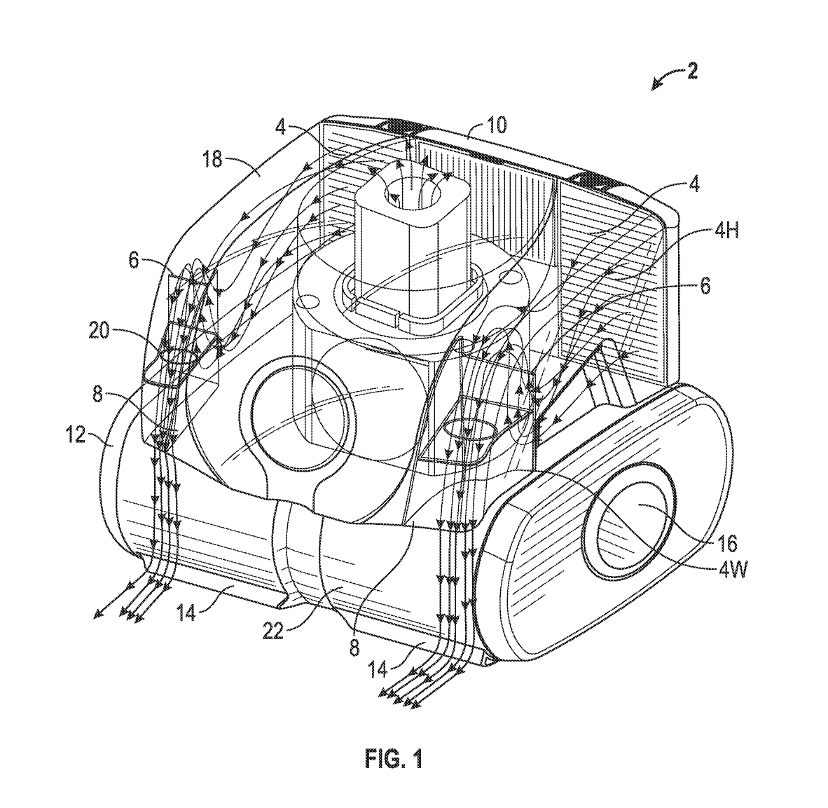

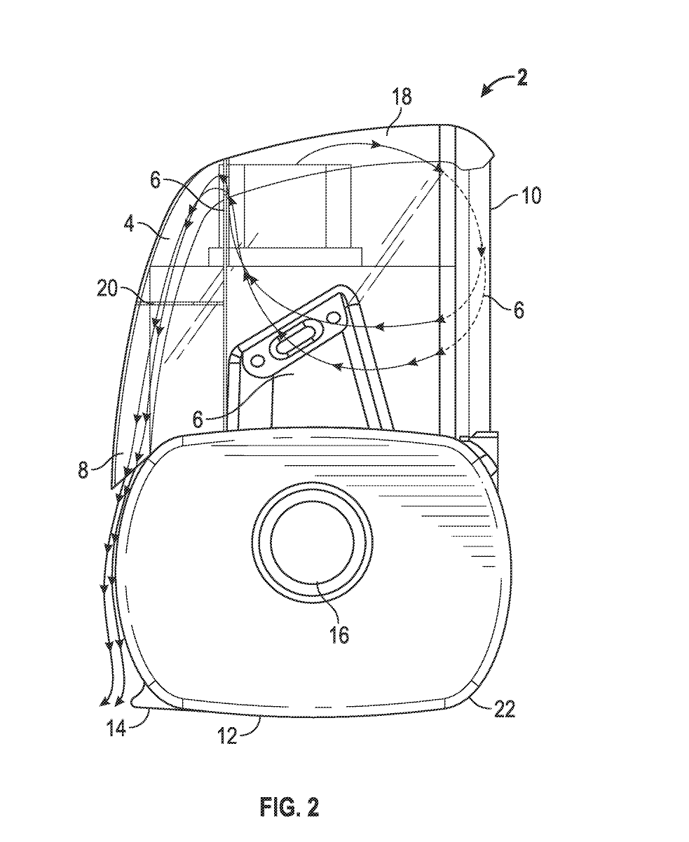

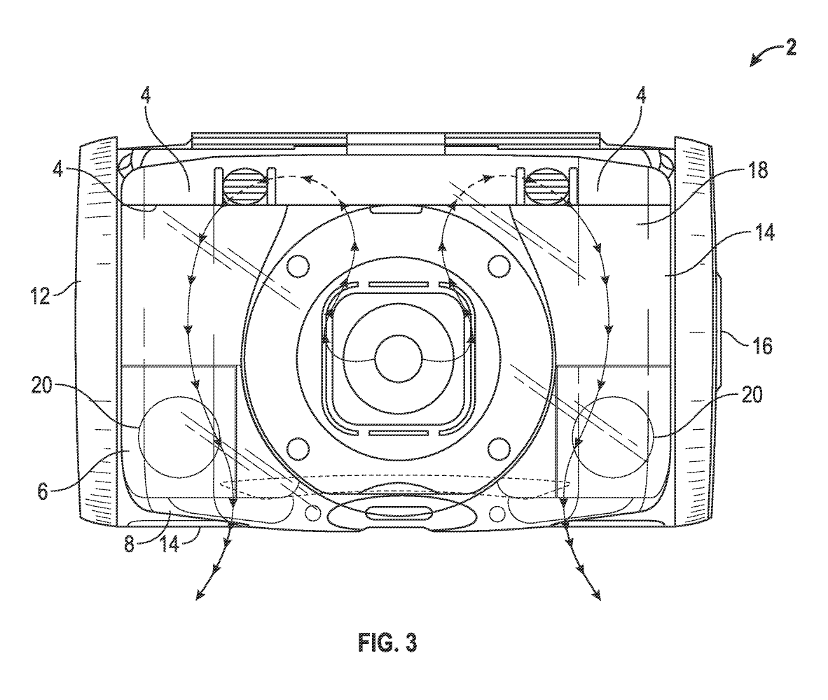

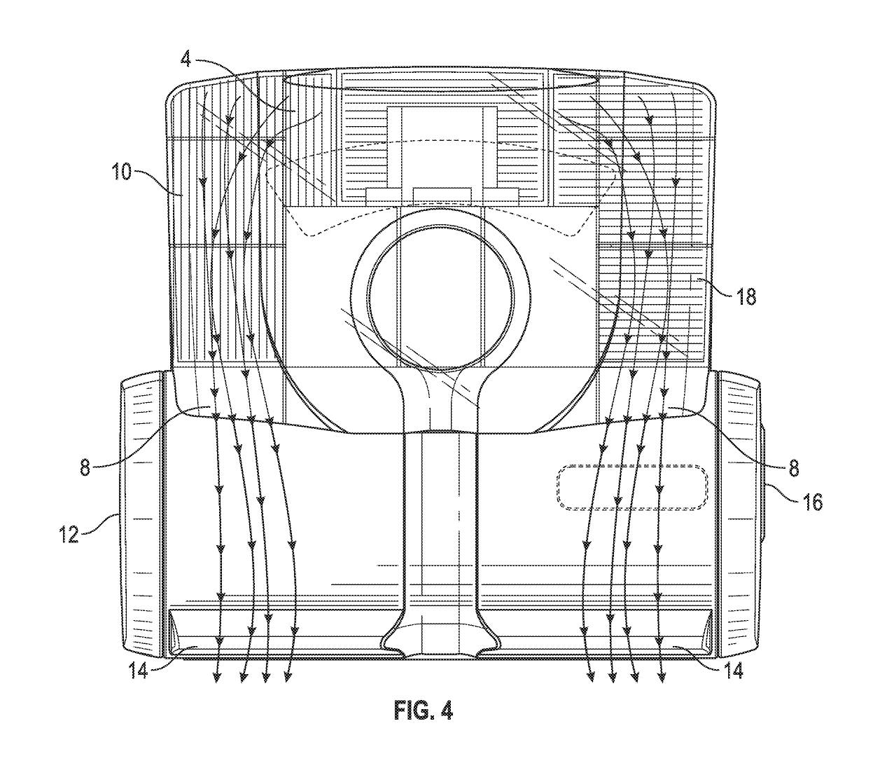

Turning now to the figures, FIG. 1 illustrates an isometric view of a first embodiment of an apparatus for controlling the exhaust of a vacuum device 2. FIG. 2 illustrates a side view of a first embodiment of an apparatus for controlling the exhaust of a vacuum device 2. FIG. 3 illustrates a top view of a first embodiment of an apparatus for controlling the exhaust of a vacuum device 2. FIG. 4 illustrates a front view of a first embodiment of an apparatus for controlling the exhaust of a vacuum device 2. These figures will be described in conjunction with one another.

The vacuum device 2 can include at least two conduits 4 capable of routing air (depicted as a series of arrows in the figures) from a first location to a second location of the vacuum device 2 and at least two baffles 6 capable of reducing the turbulence of the routed air. The at least two conduits 4 can have a height 4H and a width 4W. The at least two conduits 4 can further include at least two air chambers 20 configured to reduce the turbulence of the routed air. The apparatus can further include at least two exhaust cavities 8, an air filter 10, and a vacuum device base 12.

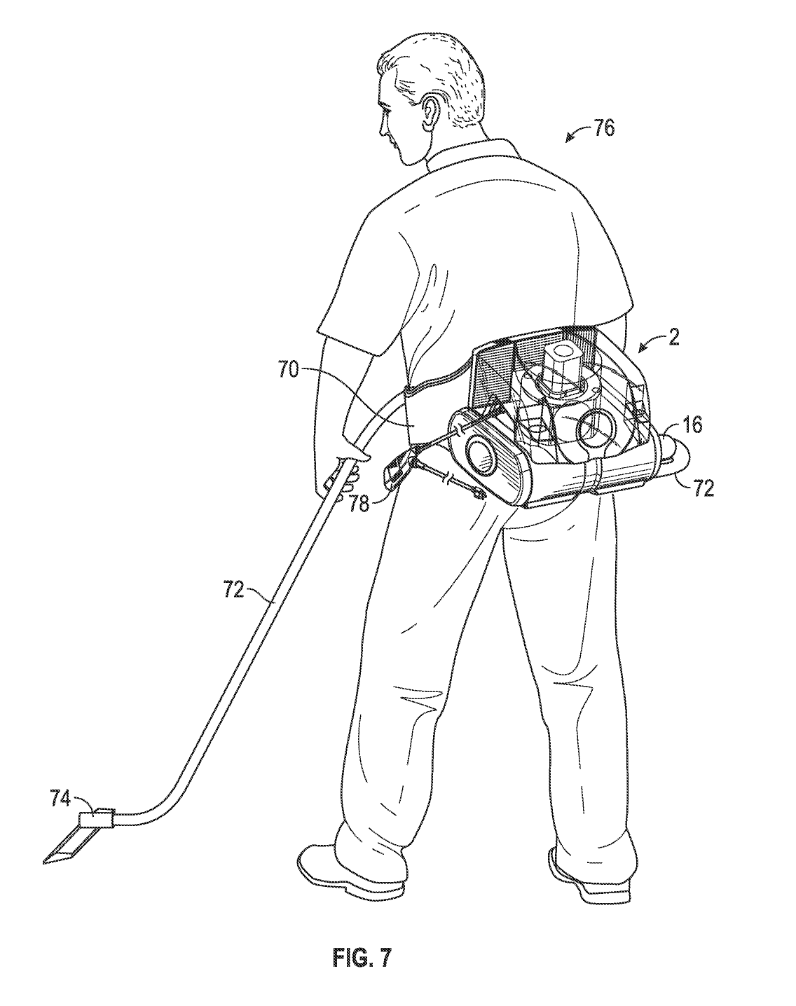

The vacuum device 2 can further include a diffuser 14 capable of increasing the turbulence of the routed air after it is discharged from the vacuum device 2. The vacuum device can include an attachment interface 16 capable of connecting an attachment conduit 72 (as shown in FIG. 7). Additionally, the vacuum device 2 can include an external cover 18 adapted to cover at least a portion of elements of the is vacuum device 2.

The at least two conduits 4 can include any channel, pathway, void, or route for air or any other gas or gaseous-like material to flow. In an exemplary and non-limiting illustrative embodiment, the at least two conduits 4 can include the pathway that air travels within the vacuum device 2 from a first location to a second location of the vacuum device 2. For example, the first location can include an external surface of an air filter 10 and the second location can include a location external to the vacuum device 2, such as the vacuum device base 12. In this example, the at least two conduits 4 can include the entire pathway of the airflow within the vacuum device 2 from the air filter 10 to the vacuum device base 12. The first location can include any location internal to the vacuum device 2. The second location can include any location either internal to, or external from, the vacuum device 2. Further, the at least two conduits 4 can be defined by the void space in between, adjacent to, or interstitially situated between or among baffles or other internal features of the vacuum device 2.

The at least two conduits 4 can be formed through of series of internal plenums and baffles that equalize the flow channel into at least two converging air streams. For example, the at least two baffles 6 can be disposed within the at least two conduits 4. In this example, the at least two baffles 6 can be designed to deflect, redirect, bend, curve, deviate, or divert the flow air of internal to the vacuum device 2 in order to minimize the turbulence of the air to be exhausted from the vacuum device 2.

Furthermore, at least two air chambers 20 can be disposed within the at least two conduits 4. The at least two air chambers 20 can be used alone, or in combination with at least two baffles 6, in order to reduce the turbulence of the routed air by channeling the routed air into at least two converging airstreams. The at least two air chambers 20 can reduce the turbulence of the routed air by funneling, routing, redirecting, or channeling the air into converging airstreams that can be subsequently is discharged, with minimal turbulence, from the vacuum device 2 at the at least two exhaust cavities 8.

The at least two conduits 4 can be formed such that air flows through the at least two conduits 4 across a wide but shallow passage. For example, the at least two conduits 4 can be formed such that the width 4W of at least a portion of the at least two conduits 4 can be larger than the height 4H of at least a portion of the at least conduits. This configuration can improve the laminar flow of the air thus reducing its turbulence prior to being exhausted through the at least two exhaust cavities 8. For example, the ratio of the width 4W of the at least two conduits 4 to the height 4H of the at least two conduits 4 can be 8:1. In another example, the ratio of the width 4W of the at least two conduits 4 to the height 4H of the at least two conduits 4 can be any ratio greater than or equal to 1:1. In an exemplary and non-limiting illustrative embodiment, the width 4W of the at least two conduits 4 can be smaller than the height of the at least two conduits 4.

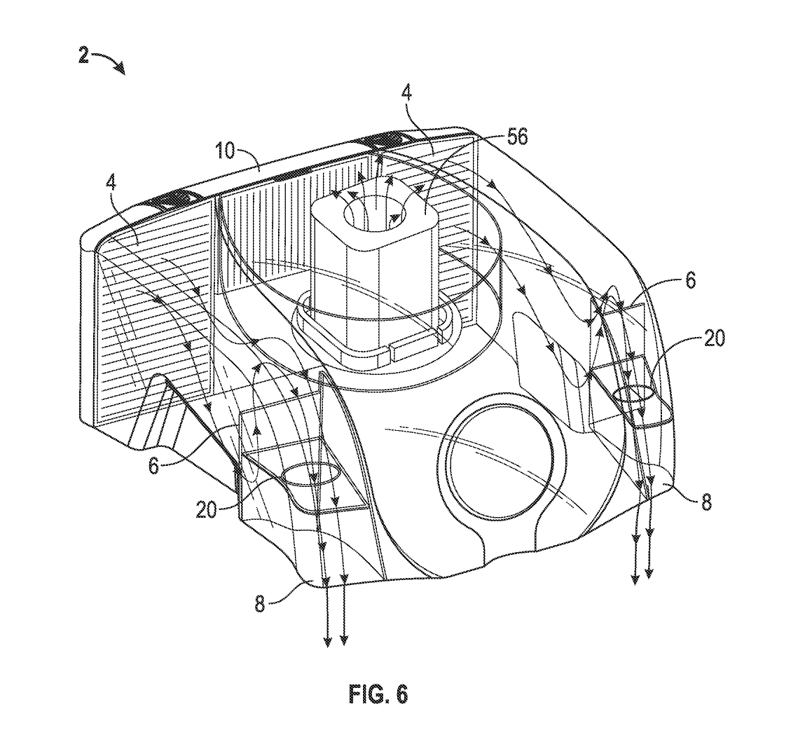

The at least two baffles 6 can include any wall, panel, divider, insert, border, or the like suitable for deflecting, redirecting, or at least partially obstructing the flow of air, gas, any gaseous-like material, sound, or light. In an exemplary and non-limiting illustrative embodiment, the at least two baffles 6 can include an internal panel of the vacuum device 2 that forms an inner or outer wall of the vacuum device 2. The at least two baffles 6 can also include an interior surface of the external cover 18 (as described in greater detail in conjunction with FIG. 6). The at least two baffles 6 can be made of injection-molded plastic, such as polypropylene, polyethylene, ABS, thermoplastics, polymerizing resin, polyacetal, polystyrene, and/or similar materials, with or without filling additives like fibers, chalks, or other flowable and settlable materials that may be injection-molded, cast, or low-pressure molded, in accordance with conventional practice.

The at least two exhaust cavities 8 can include any vent, cavity, slot, slit, opening, void, or other recessed or hollow space capable of discharging air from the at least two conduits 4 of the vacuum device 2. The at least two exhaust cavities 8 can include a separate feature coupled to the vacuum device 2. Alternatively, the at least two exhaust cavities 8 can be formed by cutting away at least a portion of the vacuum device 2. For example, the at least two exhaust cavities 8 can be formed at least in part by cutting away a portion of the vacuum device base 12.

In an exemplary and non-limiting illustrative embodiment, the at least two exhaust cavities 8 can include shallow but wide openings capable of exhausting air from the front of the vacuum device 2 in a downward direction with respect to the vacuum device 2. The at least two exhaust cavities 8 can be designed so that the exhausted air can travel along an exterior surface of the vacuum device base 12 towards the diffuser 14. By travelling closely to an exterior surface of the vacuum device base 12, the exhausted air can flow smoothly along the external surface, thus improving the laminar flow of the exhausted air. In this configuration, the turbulence of the exhausted air is minimized, thus mitigating any adverse effects on the surrounding environment or the vacuum device's 2 operator 76 (as shown in FIG. 7).

The vacuum device base 12 can be coupled to the remaining components of the vacuum device 2. Alternatively, the vacuum device base 12 can be formed as part of a single monolithic structure that includes the remaining components of the vacuum device. The vacuum device base 12 can include the attachment interface 16 that is capable of connecting an attachment conduit 72 (as shown in FIG. 7). The attachment interface can be located on a side of the vacuum device 12. Alternatively, the attachment conduit 72 can be located on the front, back, or bottom of the vacuum device base 12, or on any external surface of the vacuum device 2.

The vacuum device base 12 can further include a collection chamber (not shown). The collection chamber can be used for collecting dirt, dust, debris, or other contaminants. In an exemplary and non-limiting illustrative embodiment, the collection chamber can include a debris collection device (not shown), such as a vacuum bag. Further, the vacuum device base 12 can include a vacuum device base cover 32. The vacuum device base cover 32 can be operably coupled to, and decoupled from, the vacuum device base 12.

The diffuser 14 can include one or more spoilers, blades, fins, louvers, slats, or any other feature for disrupting, agitating, or dispersing airflow. Further, the diffuser 14 can include at least two diffusers. In this configuration, each of the diffusers can be used to diffuse the airflow of the exhaust propagating from one or more of the at least two exhaust cavities 8. The diffuser 14 can be coupled to the vacuum device base 12. Alternatively, the diffuser 14 can be formed as a part of a single monolithic structure that includes at least the vacuum device base 12.

The diffuser 14 can be employed for thermal dissipation of the exhausted air as well. For example, the diffuser 14 can disrupt the laminar flow of the exhausted air discharged from the at least two exhaust cavities 8. This discharged air can reach temperatures above the ambient temperature of the vacuum device's 2 surrounding environment. The diffuser 14 can disrupt the airflow in order to increase the turbulence of the exhausted air. By increasing this turbulence, the exhausted air can more quickly mix with the ambient air and thus normalizing the temperature gradient between the ambient air and the exhausted air.

The external cover 18 can include a cover, panel, sheet, or any other divider capable of covering all or a substantial portion of the internal components of the vacuum device 2. The external cover 18 can be operably coupled to, and decoupled from, the vacuum device 2. The external cover 18 can further include one or more flanges (not shown). The one or more flanges can be coupled to an internal surface of the external cover 18. The one or more flanges can further be formed as a part of a single monolithic structure from the external cover 18. The flanges can include any projecting fin, collar, or plate extending orthogonally or substantially orthogonally from an internal surface of the external cover 18.

Two more or flanges can be used to form at least one channel interposed between two flanges. The channel formed between the two flanges can form at least one of the at least two baffles 6. By acting as a baffle, the channel formed between the two or more flanges can deflect, redirect, bend, curve, deviate, or divert the flow of air internal to the vacuum device 2 in order to minimize the turbulence of the air to be exhausted from the vacuum device 2.

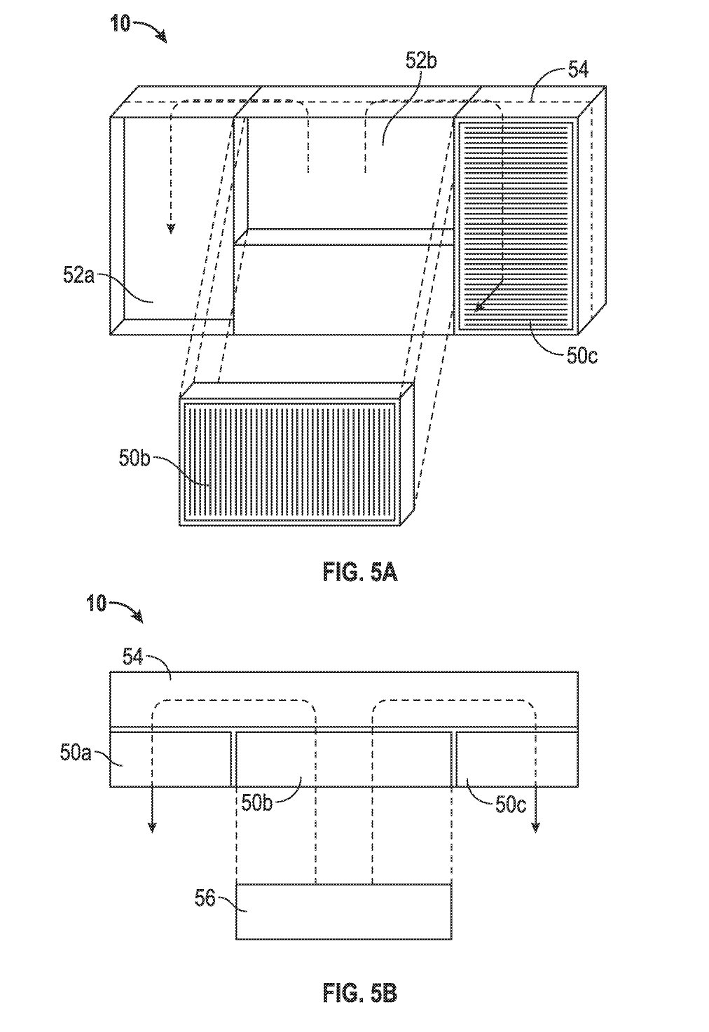

FIG. 5A illustrates a partially exploded front detailed view of a first embodiment of the air filter. FIG. 5B illustrates a top view of a first embodiment of the air filter. These figures will be described in conjunction with one another. The air filter 10 can include a filter units 50a, 50b, and 50c (collectively, “50”) and filter unit cavities 52a, 52b, and 52c (collectively “52”). The air filter 10 can further include an air filter channel 54 and an air pumping device 56. The air pumping device 56 can include a motor, pump, or any other device for raising, driving, or compressing air, gas, or other gaseous-like substance.

n an exemplary and non-limiting illustrative embodiment, the airflow (as depicted by a series of arrows in the figures) of the vacuum device 2 can travel from the air pumping device 56 through a filter unit 50b. The airflow can further travel to the air filter channel 54 which can include at least two baffles (not shown). The airflow can be deflected throughout the air filter channel 54 to one or more of the filter units (e.g., 50a and 50c). The filter units 50 can include one or more filters for filtering contaminates or other solid particulates from the air. For example, the filter units 50 can include High-Efficiency Particulate Air (HEPA) filters. The filter units 50 can is further be releasably coupled to, or decoupled from, the filter unit cavities 52. In this configuration, the filter units 50 can easily be replaced or interchanged with another filter unit 50 if necessary. For example, each of the filter units 50 can include interchangeable self-contained cartridges. Further, the air filter 10, can be releasably coupled to, or decoupled from, the vacuum device 2 (as shown in FIG. 1) so that the entire air filter can be detached and replaced if necessary.

Although FIGS. 5A and 5B only depict one exemplary and non-limiting illustrative embodiment of the air filter 10, other configurations have been contemplated as well. More specifically, the shapes, sizes, and locations of the filter units 50, the filter unit cavities 52, and the air filter channel 54 can vary in any configuration that will further aid in the process of discharging exhausted air with minimized turbulence. For example, each of the filter units 50a, 50b, and 50c can be oriented vertically, or in the alternatively, horizontally. Additionally, air filter channel 54 can include two or more air filter channels. For example, filter unit 50a can be associated with an air filter channel 54a (not shown) and filter unit 50c can be associated with an air filter channel 54c (not shown).

FIG. 6 illustrates a detailed front view of a first embodiment of an apparatus for controlling the exhaust of a vacuum device. More specifically, FIG. 6 illustrates a front view of a vacuum device 2 with the external cover 18 removed. The vacuum device 2 can include at least two conduits 4 capable of routing air from a first location to a second location of the vacuum device 2. The vacuum device 2 can further include at least two baffles 6 capable of reducing the turbulence of the routed air, and at least two exhaust cavities 8 capable of discharging the routed air from the vacuum device 2. Further, the vacuum device 2 can include an air filter 10, at least two air chambers 20, and an air pumping device 56.

In an exemplary and non-limiting illustrative embodiment, the airflow (as is depicted by a series of arrows in the figures) of the vacuum device 2 can travel from the air pumping device 56 through the air filter 10 into the at least two conduits 4. While traveling through the at least two conduits 4, the airflow can be deflected by the at least two baffles 6. Although not shown in the figure, the external cover 18 can further include the at least two baffles 6 for deflecting the airflow throughout the at least two conduits 4 when the external cover 18 is coupled to the vacuum device 2. The airflow can further be deflected into the at least two air chambers 20 towards the direction of the at least two exhaust cavities 8. By travelling through the at least two conduits 4, the airflow can be shaped and routed with the aid of the at least two baffles 6 and the at least two air chambers 20 such that the air is discharged from the at least two external cavities 8 with minimized turbulence.

Although FIG. 6 only depicts one exemplary and non-limiting illustrative embodiment of the vacuum device 2, other configurations have been contemplated as well. More specifically, the shapes, sizes, and locations of the at least two conduits 4, the at least two baffles 6, the at least two exhaust cavities 8, and the at least two air chambers 20 can vary in any configuration that will result in an exhausted airflow with minimized turbulence. For example, the at least two air chambers 20 can be formed by hollowing out a portion of the at least two baffles 6 in the shape of a slit. Additionally, the at least two baffles 6 can be coupled to the vacuum device 2 to form the at least two air chambers 20. Alternatively, the at least two baffles 6 can be formed as a single monolithic component of the vacuum device 2 to form the at least two baffles 6. Further, air originating from the air filter 10 can immediately be discharged into the at least two air chambers 20 disposed within the at least two conduits 4 before being deflected by the at least two baffles 6.

FIG. 7 illustrates a first embodiment of a system for controlling the exhaust of a vacuum device. The system can include the vacuum device 2, an attachment interface 16, and a mounting device 70. The vacuum device 2 can be a vacuum is cleaner or other device that is capable of employing a device for pumping air to remove dust, dirt, debris, or the like from the environment. The system can further include an attachment conduit 72, an attachment device 74, a vacuum device operator 76, and power supply toggling device 78. The attachment conduit 72 can be adapted for releasable attachment to, or detachment from, the vacuum device 2 at the attachment interface 16. Furthermore, the attachment conduit 72 can be adapted for releasable attachment to, or detachment from, the attachment device 74. The attachment device 74 can include one or more vacuum device attachments, such brushes, squeegees, tapered nozzles, crevasse tools, or the like.

The mounting device 70 can include a harness, strap, backpack, band, vest, or any other lightweight frame capable of being coupled to a vacuum device operator 76 in order to assist in supporting the weight of the vacuum device 2. In an exemplary and non-limiting illustrative embodiment, the mounting device 70 can include two or more adjustable shoulder straps and an adjustable waste strap. The straps of the mounting device 70 can be adjusted through a series of snaps, loops, notches, or any other means for adjusting the dimensional features of the mounting device 70 such as with the aid of VELCRO® The mounting device 70 can be operably coupled to the vacuum device 2 such that when mounted, the vacuum device 2 can remain secure and firmly in place during the vacuum device operator's 76 operation of the vacuum device 2.

In an exemplary and non-limiting illustrative embodiment, the attachment conduit 72 and the attachment device 74 can be made of injection-molded plastic, such as polypropylene, polyethylene, ABS, thermoplastics, polymerizing resin, polyacetal, polystyrene, and/or similar materials, with or without filling additives like fibers, chalks, or other flowable and settlable materials that may be injection-molded, cast, or low-pressure molded, in accordance with conventional practice.

The power supply toggling device 78 can include a switch, button, knob, lever, or the like for turning the power supply (not shown) of the vacuum device 2 on and off. The power supply can include an AC power supply (such as the power supply from a standard or commercial grade electrical socket), a DC power supply (such as a battery, photoelectric cells, or other device for storing charge), or a power supply that can be either AC or DC, such as a fuel cell. In an alternative embodiment, the power supply could include a combustible-based power supply, such as fuel derived from gasoline, petro, natural gas, or any other solid, liquid, or gaseous combustible fuel.

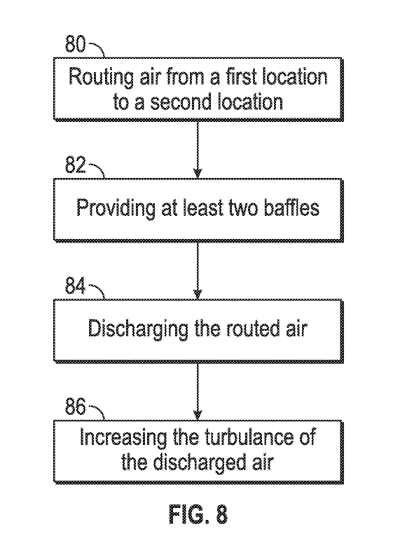

FIG. 8 illustrates a flow diagram depicting an exemplary method for controlling the exhaust of a vacuum device. The method can include the step 80 of routing air from a first location to a second location of the vacuum device through at least two conduits. The method can further include the step 82 of providing at least two baffles to reduce the turbulence of the routed air and the step 84 of discharging the routed air through at least two exhaust cavities. The method can further include the step 86 of increasing the turbulence of the routed air after it is discharged from the vacuum device.

The step 80 of routing air can include routing the air from the external surface of an air filter (e.g., first location) to a location external to the vacuum device (e.g., second location). For example, the location external to the vacuum device could be the vacuum device base. The step 80 of routing air can further include routing the air through at least two conduits that can include at least two air chambers. The at least two air chambers can be configured to further reduce the turbulence of the routed air by channeling the routed air into at least two converging airstreams. The step 80 of routing air can further include routing the air through at least two conduits such that the width of at least a portion of the at least two conduits is larger than the height of at least a portion of the at least two conduits.

The step 82 of providing at least two baffles to reduce the turbulence can include disposing at least one of the at least two baffles within the at least two conduits. The step 82 of providing at least two baffles can further include providing any type of wall, panel, divider, insert, border, or the like suitable for deflecting, redirecting, or at least partially obstructing the flow of air, gas, any gaseous-like material, sound, or light. The at least two baffles can also include an interior surface of the external cover.

The step 84 of discharging the routed air can include discharging routed air as exhaust through at least two exhaust cavities. The at least two exhaust cavities can include any vent, cavity, slot, slit, opening, void, or other recessed or hollow space capable of discharging air from the at least two conduits of the vacuum device. The step 84 of discharging the routed air can further include discharging the routed air along an exterior surface of the vacuum device base towards the diffuser. By travelling closely to an exterior surface of the vacuum device base, the exhausted air can flow smoothly along the external surface, thus improving the laminar flow of the exhausted air. In this configuration, the turbulence of the exhausted air is minimized, thus mitigating any adverse effects on the surrounding environment or the vacuum device's operator.

The step 86 of increasing the turbulence can include dissipating the airstream of the exhausted air with the aid of a diffuser. The diffuser can include one or more spoilers, blades, fins, louvers, slats, or any other feature for disrupting, agitating, or dispersing airflow. The step 86 of increasing the turbulence can further include improving the thermal dissipation of the exhausted air. By increasing the turbulence, the diffuser can disrupt the laminar flow of the exhausted air discharged from the at least two exhaust cavities. As a result, the exhausted air can more quickly mix with the ambient air thus normalizing the temperature gradient between the ambient air and the exhausted air.

Although several of the features of the invention are described throughout the disclosure as requiring a plurality of a particular element (e.g., “at least two conduits 4,” or “at least two baffles 6”), other embodiments have been contemplated as well. For example, in an exemplary and non-limiting illustrative embodiment, the vacuum device 2 can include a single conduit, a single baffle, a single exhaust cavity, and so on. In other words, although many of the disclosed elements are illustrated in the figures as being substantially mirrored across a vertical axis of the vacuum device 2, other embodiments can include a vacuum device 2 requiring only one of each element described as a plurality throughout the disclosure.

The term “coupled,” “coupling,” “coupler,” and like terms are used broadly herein and can include any method or device for securing, binding, bonding, fastening, attaching, joining, inserting therein, forming thereon or therein, or otherwise associating, for example, mechanically, magnetically, electrically, chemically, operably, directly or indirectly with intermediate elements, one or more pieces of members together and can further include without limitation integrally forming one functional member with another in a unitary fashion. The coupling can occur in any direction, including rotationally.

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

In some alternate implementations, the functions/actions/structures noted in the figures can occur out of the order noted in the block diagrams and/or operational illustrations. For example, two operations shown as occurring in succession, in fact, can be executed substantially concurrently or the operations can be executed in the reverse order, depending upon the functionality/acts/structure involved. Furthermore, although FIG. 8 illustrates one possible embodiment of a method of making a self-cleaning vacuum cleaner accessory apparatus, several other embodiments have been contemplated as well. For example, FIG. 8 recites the step 80 of routing air from a first location to a second location before the step 82 of providing at least two baffles.

Other embodiments can include performing step 82 before step 80. In some embodiments, some steps can be omitted altogether. Therefore, though not explicitly illustrated in the figures, any and all combinations or sub-combinations of the steps illustrated in FIG. 8, or additional steps described in the figures or the detailed described provided herein, can be performed in any order, with or without regard for performing the other recited steps.

Those of skill in the art should, in light of the present disclosure, appreciate that many changes can be made in the specific embodiments which are disclosed and still obtain a like or similar result without departing from the scope of the invention.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method for controlling the exhaust of a vacuum device, wherein the method comprises:
routing air from a first location to a second location of the vacuum device though a plurality of conduits;
providing a plurality of baffles to reduce the turbulence of the routed air; and
discharging the routed air through a plurality of exhaust cavities.

2. The method for controlling the exhaust of a vacuum device according to claim 1, wherein the width of at least a portion of the plurality of conduits is larger than the height of at least a portion of the plurality of conduits.

3. The method for controlling the exhaust of a vacuum device according to claim 1, wherein the first location of the vacuum device is an external surface of an air filter and the second location of the vacuum device is a location external to the vacuum device.

4. The method for controlling the exhaust of a vacuum device according to claim 1, wherein at least one of the baffles selected from the plurality of baffles is disposed within the plurality of conduits.

5. The method for controlling the exhaust of a vacuum device according to claim 1, further comprising the step of increasing the turbulence of the routed air after it is discharged from the vacuum device.

6. The method for controlling the exhaust of a vacuum device according to claim 1, wherein the plurality of conduits comprise a plurality of air chambers, wherein the plurality of air chambers are configured to further reduce the turbulence of the routed air.

7. The method for controlling the exhaust of a vacuum device according to claim 6, wherein the plurality of baffles and the plurality of air chambers reduce the turbulence of the routed air by channeling the routed air into at least two converging air streams.

8. An apparatus for controlling the exhaust of a vacuum device, wherein the apparatus comprises:
a plurality of conduits, wherein the conduits are capable of routing air from a first location to a second location of the vacuum device;
a plurality of baffles, wherein the baffles are capable of reducing the turbulence of the routed air; and
is a plurality of exhaust cavities, wherein the exhaust cavities are capable of discharging the routed air from the vacuum device.

9. The apparatus for controlling the exhaust of a vacuum device according to claim 8, wherein the width of at least a portion of the plurality of conduits is larger than the height of at least a portion of the plurality of conduits.

10. The apparatus for controlling the exhaust of a vacuum device according to claim 8, wherein the first location of the vacuum device is an external surface of an air filter and the second location of the vacuum device is a location external to the vacuum device.

11. The apparatus for controlling the exhaust of a vacuum device according to claim 8, wherein at least one of the baffles selected from the plurality of baffles is disposed within the plurality of conduits.

12. The apparatus for controlling the exhaust of a vacuum device according to claim 8, further comprising a diffuser capable increasing the turbulence of the routed air after the vacuum device discharges the routed air.

13. The apparatus for controlling the exhaust of a vacuum device according to claim 8, wherein the plurality of conduits comprise a plurality of air chambers, wherein the plurality of air chambers are configured to further reduce the turbulence of the routed air.

14. The apparatus for controlling the exhaust of a vacuum device according to claim 13, wherein the plurality of baffles and the plurality of air chambers reduce the turbulence of the routed air by channeling the routed air into at least two converging air streams.

15. A system for controlling the exhaust of a vacuum device, wherein the system comprises:
a vacuum device, wherein the vacuum device comprises;
a plurality of conduits, wherein the conduits are capable of routing air from a first location to a second location of the vacuum device;
a plurality of baffles, wherein the baffles are capable of reducing the turbulence of the routed air; and
a plurality of exhaust cavities, wherein the exhaust cavities are capable of discharging the routed air from the vacuum device; and
a mounting device, wherein the mounting device is capable of coupling the vacuum device to a vacuum operator.

16. The system for controlling the exhaust of a vacuum device according to claim 15, wherein the width of at least a portion of the plurality of conduits is larger than the height of at least a portion of the plurality of conduits.

17. The system for controlling the exhaust of a vacuum device according to claim 15, wherein at least one of the baffles selected from the plurality of baffles is disposed within the plurality of conduits.

18. The system for controlling the exhaust of a vacuum device according to claim 15, further comprising a diffuser capable increasing the turbulence of the routed air after the vacuum device discharges the routed air.

19. The system for controlling the exhaust of a vacuum device according to claim 15 wherein the plurality of conduits comprise a plurality of air chambers, wherein the plurality of air chambers are configured to further reduce the turbulence of the routed air.

20. The system for controlling the exhaust of a vacuum device according to claim 19, wherein the plurality of baffles and the plurality of air chambers reduce the turbulence of the routed air by channeling the routed air into at least two converging air streams.
